(19) United States
(12) Patent Application Publication
(10) Pub. No.: US 2013/0080954 A1
(43) Pub. Date: Mar. 28, 2013

(54) Contact Graphical User Interface

(71) Applicants: Alexandre Carlhian, Paris (FR); Alexandre Moha, Gentilly (FR); Cédric Bray, Vincennes (FR); Guillaume Borios, Boulogne-Billancourt (FR); Laurent Baumann, Campbell, CA (US); Olivier Bonnet, Paris (FR); Philippe Champeaux, Paris (FR); Jean-Pierre Ciudad, San Francisco, CA (US)

(72) Inventors: Alexandre Carlhian, Paris (FR); Alexandre Moha, Gentilly (FR); Cédric Bray, Vincennes (FR); Guillaume Borios, Boulogne-Billancourt (FR); Laurent Baumann, Campbell, CA (US); Olivier Bonnet, Paris (FR); Philippe Champeaux, Paris (FR); Jean-Pierre Ciudad, San Francisco, CA (US)

(73) Assignee: APPLE INC., Cupertino, CA (US)

(21) Appl. No.: 13/244,128

(22) Filed: Sep. 23, 2011

(51) Int. Cl. G06F 3/048

(52) U.S. Cl. 715/769; 715/838

(57) ABSTRACT

A contact GUI is presented on a display of a device. The GUI displays visual representations of a set of contacts. The contacts can be ranked according to a ranking system and the visual representations of the contacts can be displayed in the GUI according to rank. The ranking can be based on previous interactions with the contact or an upcoming event associated with the contact. A user can transfer a file to a contact by dragging and dropping a file icon onto a visual representation for a recipient contact. The communication mode for the transfer can be determined manually by the user or automatically based on the contact's current online status. Selection of a visual representation of a contact exposes a window with a timeline display providing descriptors for communications with the contact.

### TECHNICAL FIELD

This disclosure relates generally to graphical user interfaces (GUIs), and more particularly to GUIs for facilitating interactions with contacts.

### BACKGROUND

Modern electronic devices (e.g., smart phones, tablets, laptop computers) enable users to interact using a variety of communication technologies. In addition to telephony and email, users can communicate through text messaging, online social networks and microblogging services. Users can store information for friends, family members, co-workers, customers and clients (collectively, “contacts”) on their device using a virtual address book. The address book can store contact information for a contact, including telephone numbers, email addresses, Web addresses, home addresses and the like. Users can exchange information and content, including electronic documents and books, digital images, videos, music and the like. This content can be stored on a network where it can be accessed by others. For example, content can be posted by user on their social network account where their designated “friends” can view and comment on the content.

Although these modern electronic devices have enriched the lives of users around the world, many of these devices fail to provide a simple and intuitive user experience when exchanging communications and content with contacts.

### SUMMARY

A contact GUI is presented on a display of a device. The GUI displays visual representations of a set of contacts. The contacts can be ranked according to a ranking system and the visual representations of the contacts can be displayed in the GUI according to rank. The ranking can be based on previous interactions with the contact or an upcoming event associated with the contact. A user can transfer a file to a contact by dragging and dropping a file icon onto a visual representation for a recipient contact. The communication mode for the transfer can be determined manually by the user or automatically based on the contact's current online status. Selection of a visual representation of a contact exposes a window with a timeline display providing descriptors for communications with the contact. The window can include user interface elements that can be selected by the user to communicate with the contact.

In some implementations, a method includes: generating a graphical user interface (GUI) for display on a device; determining a set of contacts; displaying the GUI on the device, the GUI including thumbnails representing the set of contacts; receiving first user input including dragging and dropping a file icon representing a file onto a thumbnail; responsive to the first user input, selecting a preferred communication mode for transferring the file to the contact; and transferring the file to the contact using the preferred communication mode.

In some implementations, a method includes: generating a graphical user interface (GUI) for display on a device; determining a set of contacts, ranking the contacts according to a ranking system; and displaying thumbnails representing the set of contacts in the GUI according to the ranking.

Other implementations are directed to devices, systems and computer-readable mediums.

Particular implementations of the disclosed implementations provide one or more advantages, including but not limited to: 1) providing a centralized location for a user's contacts to facilitate interactions with the contacts, including communicating with the contacts using automatically selected communication modes; 2) facilitating the exchange of data with contacts using a simple drag and drop operation; 3) providing links to network sources, such as social networks and microblogging services; and 4) aggregating communications and content received from contacts and presenting the communications and content in a timeline display to facilitate search and access of the communications and content.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1 illustrates an exemplary contact GUI for displaying visual representations of a set of contacts and facilitating a file exchange with a contact.

FIG. 2 illustrates an exemplary window for a contact including a timeline display.

FIG. 3 is a flow diagram of an exemplary process for file exchange with a contact using the GUI of FIG. 1.

FIG. 4 is a flow diagram of an exemplary process for generating the GUI of FIG. 1.

FIG. 5 illustrates an exemplary operating environment for a device that is capable of implementing the features described in reference to FIGS. 1-4.

FIG. 6 illustrates an exemplary device architecture for implementing the features described in reference to FIGS. 1-5.

Like reference-symbols in the various drawings indicate like elements.

### DETAILED DESCRIPTION

### Exemplary GUI for File Exchange

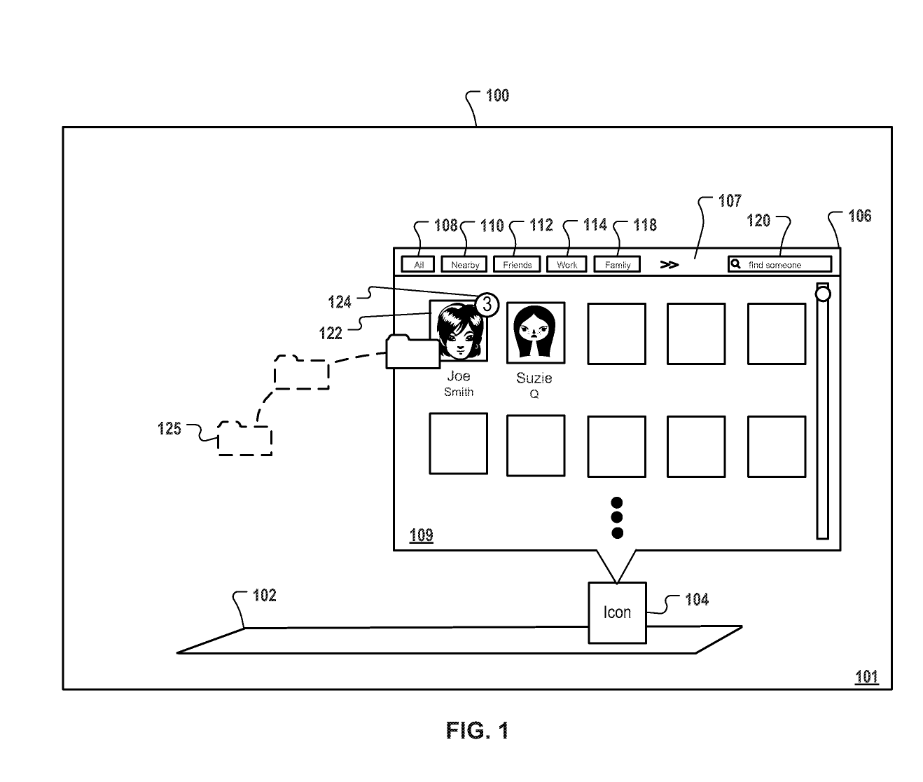

FIG. 1 illustrates an exemplary GUI for displaying visual representations of a set of contacts and facilitating a file exchange with a contact. In some implementations, GUI 106 can be invoked on display 100 of a device. The device can be a desktop computer, laptop computer, smart phone, electronic tablet, television screen or any other device capable of displaying GUI 100. Display 100 can be a touch sensitive surface responsive to multi-touch input and gestures.

In the example shown, GUI 106 can be invoked when a user selects icon 104 from dock 102 on virtual desktop 101. In other implementations, GUI 106 can be invoked from an application toolbar, menu or other user interface element. GUI 106 can be invoked manually by a user or automatically by an application or operating system.

GUI 106 can include toolbar 107 and contacts area 109. Toolbar 107 can include one or more user interface elements (e.g., virtual buttons) to allow the user to select (filter) for display a subset of contacts from the set of contacts. Contact information can be stored in a local virtual “address book” or remotely on a network device.

In the example shown, “All” button 108 displays all contacts in a user's contact database (e.g., a virtual address book) in contacts area 109. “Nearby” button 110 displays contacts in contacts area 109 that are within a defined physical distance from the device. Nearby contacts can be determined using a tracking service that tracks the locations of mobile devices equipped with positioning systems (e.g., GPS, WiFi, Cell ID) and shares those locations with other devices. Nearby contacts can also be determined based on connection to the same local network as the user's device or detected by the user's device using short-range communication technology (e.g., Bluetooth). “Friends” button 112 displays contacts that have been previously identified by the user as “friends.” “Work” button 114 displays contacts that have been previously identified by the user as co-workers. “Family” button 116 displays contacts that have been previously identified by the user as family members. Other types of contact groups are also possible, such as classmates, club members, etc. A search field 120 can be included in toolbar 107 for searching for contacts in local and remote databases.

Contacts area 109 can include a visual representation 122 for each contact. A visual representation 122 (also referred to as “thumbnails” or “thumbnails 122”) can be a digital photos of the contact, avatar, icon or any other graphical object that can be used to represent a contact. Thumbnails 122 can be displayed in a grid format in contacts area 109. In the example shown, there are 10 thumbnails shown in a grid format. Thumbnails 122 can include a user interface element 124 (e.g., a badge) to indicate a total number of unread communications (e.g., unread emails or unread text messages). Contacts area 109 can be scrolled to display additional contacts.

In some implementations, thumbnails 122 can be sorted in contacts area 109 based on a ranking system. The ranking system can be based on previous interactions with a contact as well as upcoming events associated with the contact. Generally, a contact with a high rank is an individual that the user communicates with often. A number of interactions or types of interactions with a contact can be used to determine a rank for that contact. Some examples of interactions can include but are not limited to calendar events, exchanged emails, chat discussions, mentions or direct messages on microblogging service, etc.

In some implementations, the ranking of contacts can start with a first contact at the top left corner of a first row of a grid in contacts area 109 (the highest-ranking contact). Each contact in the first row can share the same rank as the first contact or have a progressively lessor rank based on its position in the first row. The rows below the first rows can have progressively lower ranked contacts. In the example shown, Joe Smith has a higher rank than Suzie Q based on their respective positions in the first row of the grid.

In some implementations, GUI 106 can facilitate the exchange of data (e.g., files) between contacts. In the example shown, the user drags and drops file icon 125 on desktop 101 to thumbnail 122 (the thumbnail for Joe Smith). When the user drops file icon 125 on thumbnail 122, the file is automatically transferred to a device operated by Joe Smith. In some implementations, the file can be transferred using a communication mode that is selected based on the online status of Joe Smith. If Joe is online, then the file can be transferred to the contact using chat session technology, such as iChat™ developed by Apple Inc. of Cupertino, Calif., or uploaded to the contact through a social network or microblogging Web site or service. If Joe is not online, then the file can be transferred using, for example, email or Multimedia Message Service (MMS). In the case of email transfer, an email form can be generated automatically and addressed with the contact's email address. The contact's email address can be obtained from, for example, a local virtual address book on the user's device or from a network device. The file can be attached automatically to the email.

In some implementations, the user can use a settings menu or other user interface element to select a default mode of communication or to specify an ordered list of communication modes. For example, the user can select a primary mode of communication and one or more secondary modes of communication that can be executed in the specified order if the primary communication mode fails or is unavailable.

### Exemplary Timeline Display

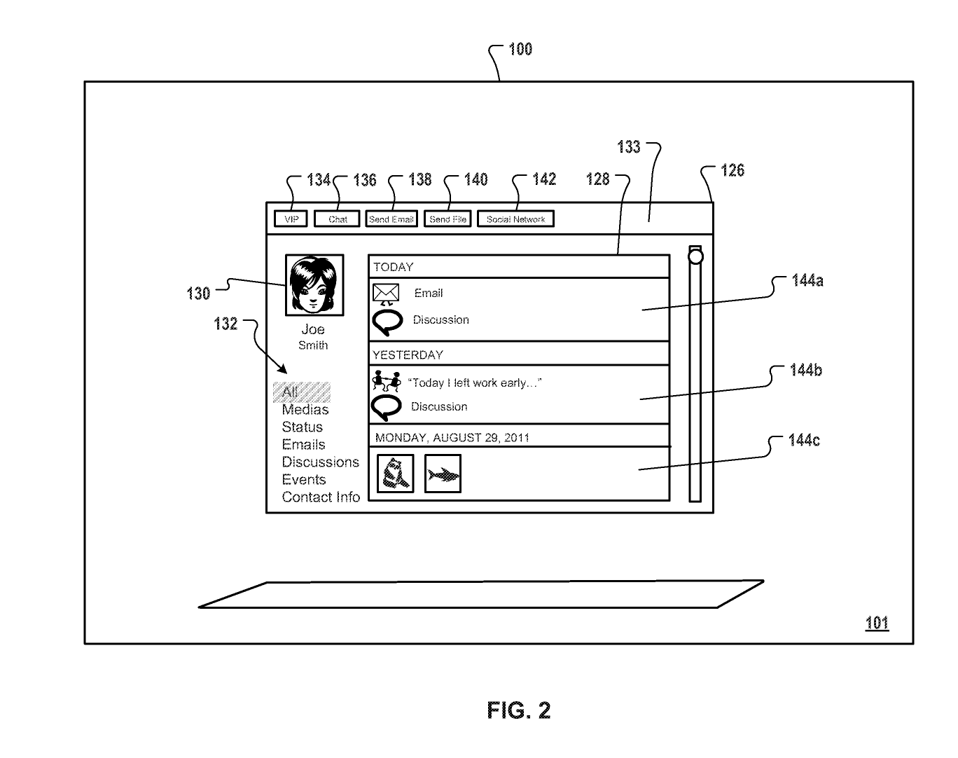

FIG. 2 illustrates an exemplary window 126 including a timeline display 128. In some implementations, when the user clicks or touches thumbnail 122, window 126 is presented for the contact corresponding to thumbnail 122. Window 126 can include toolbar 133, thumbnail 130, information menu 132 and timeline display 128.

Timeline display 128 can be a scrollable display area for displaying communications and media received from multiple sources of communication. Timeline display 128 can be divided into sections according to the day received. For example, top section 144a displays communications received on the current day (“Today”), section 144b displays communications received the previous day (“Yesterday”) and section 144c displays media received two days earlier.

Each section 144a-144c can display multiple types of communications and media for the contact. Some examples of communication types can include but are not limited to online status, emails, chat discussions, events and contact information. The user can click or touch a descriptor (e.g., an icon or text link) for the communication or media in timeline display 128 to display, read or play the communication or media. The communication types that are displayed in timeline display 128 can be selected by the user from information menu 132. In the example shown, the users selected the “all” option for displaying all communications and media in timeline display 128. In the example shown, section 144a displays icons for email and chat discussions, section 144b displays icons for social network postings and chat discussions and section 144c displays media. The media can be, for example, digital photos downloaded from a photo gallery posted on the contact's social network account. Other media can include videos, audio files (e.g., voice messages, songs, ring tones) and electronic documents and books.

In some implementations, toolbar 133 can include user interface elements VIP 134, Chat 136, Send Email 138, Send File 140 and Social Network 142. VIP 134 allows the user to force a specific contact to stay at the top of contacts area 109 by marking or flagging the contact as “VIP.” VIP 134 can be used for contacts that do not communicate often with the user (e.g., through the Internet) but are still important to the user. Thus, a contact that is marked as “VIP” will have its default ranking based on previous interactions overridden.

Chat 136 and Send Email 138 can be selected by the user to invoke an email or messaging (chat) session. For the email application, the email address field can be automatically populated with the contact's email address. For the messaging session, the contacts telephone number can be used to set up a new chat session (discussion) with the contact. The email address and telephone number can be retrieved from a virtual address book on the user's device or stored on a network device. Send File 140 can be selected by the user to exchange files with the contact. Send File 140 provides an alternative file exchange method to the drag and drop operation described in reference to FIG. 1. Social Network 142 can be selected by the user to access a social networking, microblogging or other online site or service. Social Network 142 can expose a menu with several options for the user. For example, options can be exposed for creating a new message, viewing their “wall” and viewing media (e.g., digital photos).

### Exemplary Processes

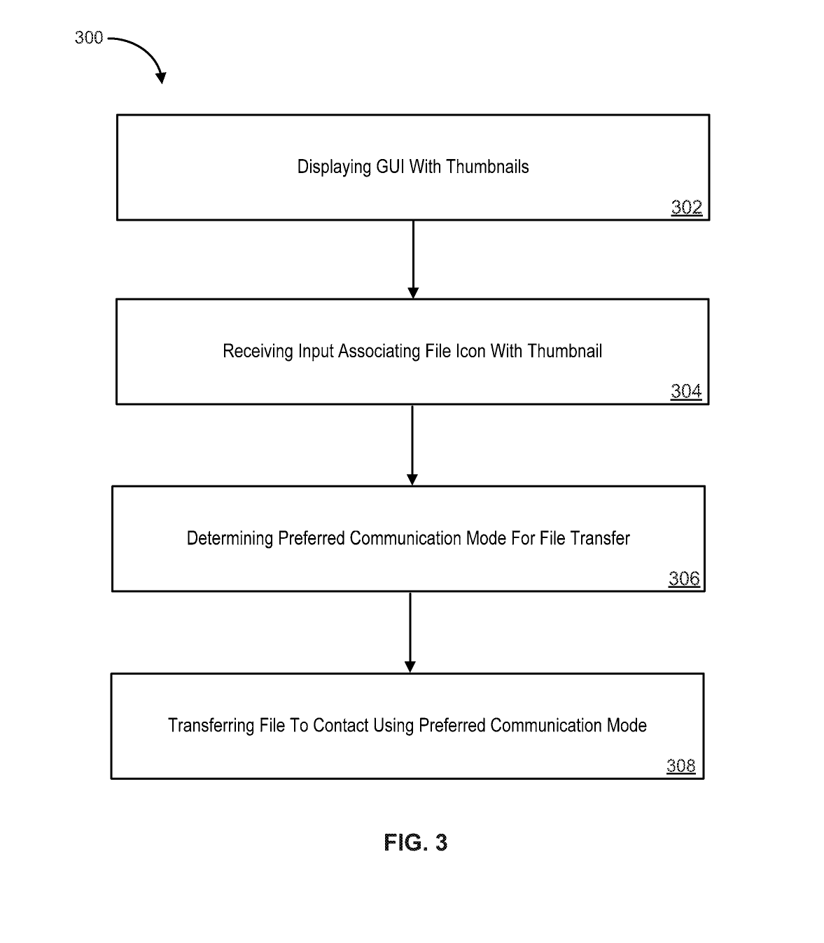

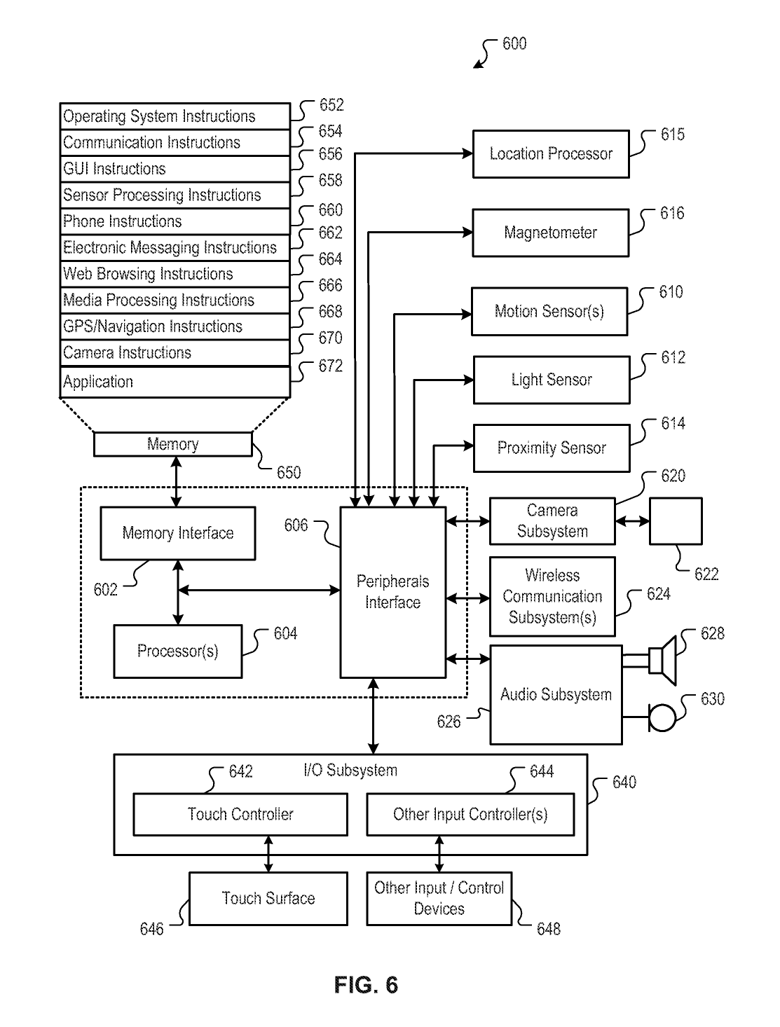

FIG. 3 is a flow diagram of an exemplary process 300 for data exchange with a contact using GUI 100 of FIG. 1. In some implementations, process 300 can be implemented by the device architecture described in reference to FIG. 6.

In some implementations, process 300 can begin by displaying a contact GUI with thumbnails (302). The contact GUI can be invoked from a dock on a virtual desktop or from a user interface element (e.g., menu, sidebar, toolbar). The GUI can be invoked manually by a user or automatically by an application or operating system. The thumbnails can be displayed in a grid format according to rank. The rank can be based on previous interactions with the contact or upcoming events associated with the contact, which can be retrieved from an electronic calendar, for example.

Process 300 can continue by receiving input associating a file icon with a thumbnail (304). For example, the user can drag and drop a file icon onto a thumbnail corresponding to the recipient contact.

Process 300 can continue by determining a preferred communication mode based on an online status of the contact (306). If the contact is online, the preferred communication mode may be instant messaging or through a social network site. If the contact is offline, the preferred communication mode may be email.

Process 300 can continue by transferring the file to the contact using the preferred communication mode (308). The transfer can be performed using known communication technologies, including but not limited to Simple Mail Transfer Protocol (SMTP), Transmission Control Protocol/Internet Protocol (TCP/IP), User Datagram Protocol (UDP), Short Message Service (SMS), MMS, FTP, Bluetooth, WiFi, etc.

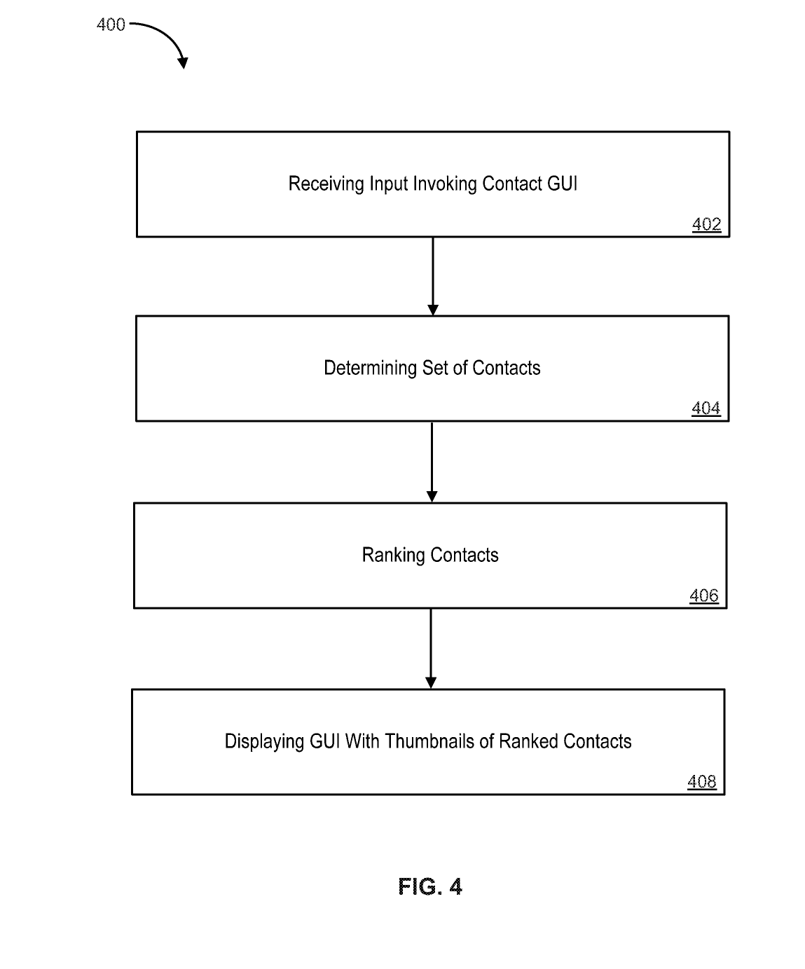

FIG. 4 is a flow diagram of an exemplary process 400 for generating GUI 100 of FIG. 1. In some implementations, process 400 can be implemented by the device architecture described in reference to FIG. 6.

Process 400 can begin by receiving input invoking a contact GUI (402). For example, the user can click or touch an icon on a dock of virtual desktop to invoke the contact GUI. Alternatively, the user can invoke the contact GUI through a menu or other user interface element. The contact GUI can be invoked by the user manually or by an application automatically.

Process 400 can continue by determining a set of contacts to display in the contact GUI (404). The contacts can be collected from a local virtual address book or from a network device. In some implementations, contacts can be collected from the user's social networking, microblogging or other online network services or accounts.

Process 400 can continue by ranking the contacts according to a ranking system (406). The ranking system can be based on previous interactions with the contact, such as the number and type of interactions, which can be stored in memory of the user device or on a network device. The user can also mark or flag a contact to indicate the importance of the contact for purposes of display in the contact GUI.

Process 400 can continue by displaying the contact GUI with thumbnails representing the determined contacts (408). For example, the thumbnails can be displayed in a grid format according to rank, with higher ranked contacts having their thumbnails displayed at the top of the contact GUI.

### Exemplary Operating Environment

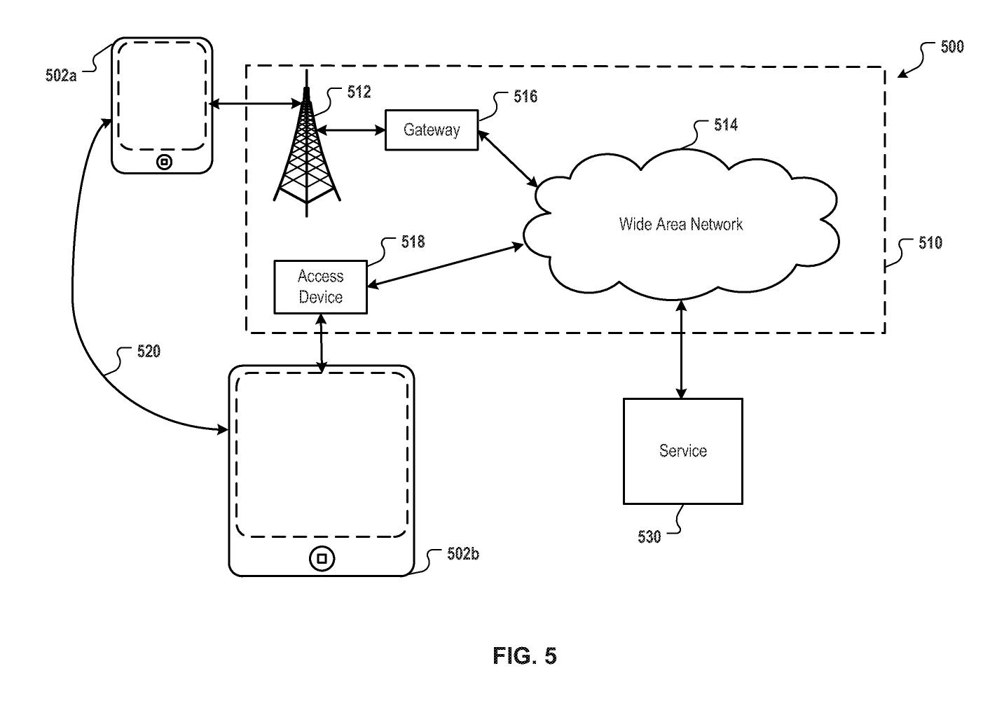

FIG. 5 illustrates an exemplary operating environment 500 for a device that is capable of implementing the features described in reference to FIGS. 1-4. In some implementations, devices 502a and 502b can communicate over one or more wired or wireless networks 510. For example, wireless network 512 (e.g., a cellular network) can communicate with a wide area network (WAN) 514 (e.g., the Internet) by use of gateway 516. Likewise, access device 518 (e.g., IEEE 802.11g wireless access device) can provide communication access to WAN 514. Devices 502a, 502b can be any device capable of displaying a GUI for displaying contact GUI, including but not limited to portable computers, smart phones and electronic tablets. In some implementations, the devices 502a, 502b do not have to be portable but can be a desktop computer, television system, kiosk system or the like.

In some implementations, both voice and data communications can be established over wireless network 512 and access device 518. For example, device 502a can place and receive phone calls (e.g., using voice over Internet Protocol (VoIP) protocols), send and receive e-mail messages (e.g., using SMPTP or Post Office Protocol 3 (POP3)), and retrieve electronic documents and/or streams, such as web pages, photographs, and videos, over wireless network 512, gateway 516, and WAN 514 (e.g., using Transmission Control Protocol/Internet Protocol (TCP/IP) or User Datagram Protocol (UDP)). Likewise, in some implementations, device 502b can place and receive phone calls, send and receive e-mail messages, and retrieve electronic documents over access device 518 and WAN 514. In some implementations, device 502a or 502b can be physically connected to access device 518 using one or more cables and access device 518 can be a personal computer. In this configuration, device 502a or 502b can be referred to as a “tethered” device.

Devices 502a and 502b can also establish communications by other means. For example, wireless device 502a can communicate with other wireless devices (e.g., other devices 502a or 502b, cell phones) over the wireless network 512. Likewise, devices 502a and 502b can establish peer-to-peer communications 520 (e.g., a personal area network) by use of one or more communication subsystems, such as the Bluetooth™ communication devices. Other communication protocols and topologies can also be implemented.

Devices 502a or 502b can communicate with service 530 over the one or more wired and/or wireless networks 510. For example, service 530 can host a Web-based social networking or microblogging application that provides Web pages to client devices that include the features described in reference to FIGS. 1-4.

Device 502a or 502b can also access other data and content over one or more wired and/or wireless networks 510. For example, content publishers, such as news sites, Really Simple Syndication (RSS) feeds, Web sites and developer networks can be accessed by device 502a or 502b. Such access can be provided by invocation of a web browsing function or application (e.g., a browser) running on the device 502a or 502b.

Devices 502a and 502b can exchange files over one or more wireless or wired networks 510 either directly or through service 530.

### Exemplary Device Architecture

FIG. 6 is a block diagram illustrating exemplary device architecture that implements features and processes described in reference to FIGS. 1-5. Architecture 600 can be implemented in any device for generating the features described in reference to FIGS. 1-4, including but not limited to portable or desktop computers, smart phones and electronic tablets, television systems, game consoles, kiosks and the like. Architecture 600 can include memory interface 602, data processor(s), image processor(s) or central processing unit(s) 604, and peripherals interface 606. Memory interface 602, processor(s) 604 or peripherals interface 606 can be separate components or can be integrated in one or more integrated circuits. The various components can be coupled by one or more communication buses or signal lines.

Sensors, devices, and subsystems can be coupled to peripherals interface 606 to facilitate multiple functionalities. For example, motion sensor 610, light sensor 612, and proximity sensor 614 can be coupled to peripherals interface 606 to facilitate orientation, lighting, and proximity functions of the device. For example, in some implementations, light sensor 612 can be utilized to facilitate adjusting the brightness of touch surface 646. In some implementations, motion sensor 610 (e.g., an accelerometer, gyros) can be utilized to detect movement and orientation of the device. Accordingly, display objects or media can be presented according to a detected orientation (e.g., portrait or landscape).

Other sensors can also be connected to peripherals interface 606, such as a temperature sensor, a biometric sensor, or other sensing device, to facilitate related functionalities.

Location processor 615 (e.g., GPS receiver) can be connected to peripherals interface 606 to provide geo-positioning. Electronic magnetometer 616 (e.g., an integrated circuit chip) can also be connected to peripherals interface 606 to provide data that can be used to determine the direction of magnetic North. Thus, electronic magnetometer 616 can be used as an electronic compass.

Camera subsystem 620 and an optical sensor 622, e.g., a charged coupled device (CCD) or a complementary metal-oxide semiconductor (CMOS) optical sensor, can be utilized to facilitate camera functions, such as recording photographs and video clips.

Communication functions can be facilitated through one or more communication subsystems 624. Communication subsystem(s) 624 can include one or more wireless communication subsystems. Wireless communication subsystems 624 can include radio frequency receivers and transmitters and/or optical (e.g., infrared) receivers and transmitters. Wired communication system can include a port device, e.g., a Universal Serial Bus (USB) port or some other wired port connection that can be used to establish a wired connection to other computing devices, such as other communication devices, network access devices, a personal computer, a printer, a display screen, or other processing devices capable of receiving or transmitting data. The specific design and implementation of the communication subsystem 624 can depend on the communication network(s) or medium(s) over which the device is intended to operate. For example, a device may include wireless communication subsystems designed to operate over a global system for mobile communications (GSM) network, a GPRS network, an enhanced data GSM environment (EDGE) network, 802.x communication networks (e.g., WiFi, WiMax, or 3G networks), code division multiple access (CDMA) networks, and a Bluetooth™ network. Communication subsystems 624 may include hosting protocols such that the device may be configured as a base station for other wireless devices. As another example, the communication subsystems can allow the device to synchronize with a host device using one or more protocols, such as, for example, the TCP/IP protocol, HTTP protocol, UDP protocol, and any other known protocol.

Audio subsystem 626 can be coupled to a speaker 628 and one or more microphones 630 to facilitate voice-enabled functions, such as voice recognition, voice replication, digital recording, and telephony functions.

I/O subsystem 640 can include touch controller 642 and/or other input controller(s) 644. Touch controller 642 can be coupled to a touch surface 646. Touch surface 646 and touch controller 642 can, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with touch surface 646. In one implementation, touch surface 646 can display virtual or soft buttons and a virtual keyboard, which can be used as an input/output device by the user.

Other input controller(s) 644 can be coupled to other input/control devices 648, such as one or more buttons, rocker switches, thumb-wheel, infrared port, USB port, and/or a pointer device such as a stylus. The one or more buttons (not shown) can include an up/down button for volume control of speaker 628 and/or microphone 630.

In some implementations, device 600 can present recorded audio and/or video files, such as MP3, AAC, and MPEG files. In some implementations, device 600 can include the functionality of an MP3 player and may include a pin connector for tethering to other devices. Other input/output and control devices can be used.

Memory interface 602 can be coupled to memory 650. Memory 650 can include high-speed random access memory or non-volatile memory, such as one or more magnetic disk storage devices, one or more optical storage devices, or flash memory (e.g., NAND, NOR). Memory 650 can store operating system 652, such as Darwin, RTXC, LINUX, UNIX, OS X, WINDOWS, or an embedded operating system such as VxWorks. Operating system 652 may include instructions for handling basic system services and for performing hardware dependent tasks. In some implementations, operating system 652 can include a kernel (e.g., UNIX kernel).

Memory 650 may also store communication instructions 654 to facilitate communicating with one or more additional devices, one or more computers or servers. Communication instructions 654 can also be used to select an operational mode or communication medium for use by the device, based on a geographic location (obtained by the GPS/Navigation instructions 668) of the device. Memory 650 may include graphical user interface instructions 656 to facilitate graphic user interface processing, such as generating the contact GUI and window/timeline display shown in FIGS. 1-2; sensor processing instructions 658 to facilitate sensor-related processing and functions; phone instructions 660 to facilitate phone-related processes and functions; electronic messaging instructions 662 to facilitate electronic-messaging related processes and functions; web browsing instructions 664 to facilitate web browsing-related processes and functions; media processing instructions 666 to facilitate media processing-related processes and functions; GPS/Navigation instructions 668 to facilitate GPS and navigation-related processes; camera instructions 670 to facilitate camera-related processes and functions; and instructions 672 for an application that is capable of displaying a contact GUI and window/timeline display, as described in reference to FIGS. 1-4. The memory 650 may also store other software instructions for facilitating other processes, features and applications, such as applications related to navigation, social networking, location-based services or map displays.

Each of the above identified instructions and applications can correspond to a set of instructions for performing one or more functions described above. These instructions need not be implemented as separate software programs, procedures, or modules. Memory 650 can include additional instructions or fewer instructions. Furthermore, various functions of the mobile device may be implemented in hardware and/or in software, including in one or more signal processing and/or application specific integrated circuits.

The features can be implemented in a computer system that includes a back-end component, such as a data server, that includes a middleware component, such as an application server or an Internet server, or that includes a front-end component, such as a client computer having a graphical user interface or an Internet browser, or any combination of them. The components of the system can be connected by any form or medium of digital data communication such as a communication network. Some examples of communication networks include LAN, WAN and the computers and networks forming the Internet.

The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments can be implemented using an API. An API can define on or more parameters that are passed between a calling application and other software code (e.g., an operating system, library routine, function) that provides a service, that provides data, or that performs an operation or a computation. The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API. In some implementations, an API call can report to an application the capabilities of a device running the application, such as input capability, output capability, processing capability, power capability, communications capability, etc.

A number of implementations have been described. Nevertheless, it will be understood that various modifications may be made. For example, other steps may be provided, or steps may be eliminated, from the described flows, and other components may be added to, or removed from, the described systems. Accordingly, other implementations are within the scope of the following claims.

What is claimed is:

1. A method comprising:
generating a graphical user interface (GUI) for display on a device;
determining a set of contacts;
displaying the GUI on the device, the GUI including thumbnails representing the set of contacts;
receiving first user input including dragging and dropping a file icon representing a file onto a thumbnail;
responsive to the first user input, selecting a preferred communication mode for transferring the file to the contact; and
transferring the file to the contact using the preferred communication mode.

2. The method of claim 1, where determining a set of contacts includes collecting contacts from a virtual address book on the device.

3. The method of claim 1, where selecting a communication mode further comprises:
determining the online status of the contact; and
selecting the preferred communication mode based on the online status.

4. The method of claim 1, further comprising:
displaying a toolbar in the GUI, the toolbar including one or more user interface elements selectable by the user to determine a subset of contacts from the set of contacts for display in the GUI.

5. The method of claim 1, further comprising:
displaying a user interface element on a visual representation for indicating a number of unread communications from the contact corresponding to the visual representation.

6. The method of claim 1, further comprising:
receiving second user input associated with a thumbnail of a contact displayed in the GUI; and
responsive to the second user input, presenting a window for the contact having a timeline display, the timeline display including sections corresponding to days, the sections displaying a descriptor for each communication or media received from the contact.

7. The method of claim 6, further comprising:
receiving third user input selecting a type of communication to be displayed in the sections of the timeline display; and
displaying only communications of the selected communication type in the sections of the timeline display.

8. The method of claim 6, further comprising:
receiving third user input selecting a network site or service associated with the contact; and
displaying options for interacting with the contact through the network site or service.

9. The method of claim 1, where media associated with the contact is displayed in at least one section of the timeline display.

10. The method of claim 9, where the media is received from a network service associated with the contact.

11. A method comprising:
generating a graphical user interface (GUI) for display on a device;
determining a set of contacts;
ranking the contacts according to a ranking system; and
displaying thumbnails representing the set of contacts in the GUI according to the ranking.

12. The method of claim 11, where determining a set of contacts includes collecting contacts from a virtual address book on the device.

13. The method of claim 11, where ranking the contacts according to a ranking system, comprises:
ranking a contact based on a previous interaction with the contact.

14. The method of claim 11, where ranking the contacts according to a ranking system, comprises:
ranking a contact based on an upcoming event associated with the contact.

15. A system comprising:
one or more processors;
memory coupled to the one or more processors and configured to store instructions for causing the one or more processors to perform operations comprising:
generating a graphical user interface (GUI) for display on a device;
determining a set of contacts;
displaying the GUI on the device, the GUI including thumbnails representing the set of contacts;
receiving first user input including dragging and dropping a file icon representing a file onto a thumbnail;
responsive to the first user input, selecting a preferred communication mode for transferring the file to the contact; and
transferring the file to the contact using the preferred communication mode.

16. The system of claim 15, where determining a set of contacts includes collecting contacts from a virtual address book on the device.

17. The system of claim 15, where selecting a communication mode further comprises:
determining the online status of the contact; and
selecting the preferred communication mode based on the online status.

18. The system of claim 15, further comprising instructions for performing the operation of:
displaying a toolbar in the GUI, the toolbar including one or more user interface elements that can be selected by a user to determine a subset of contacts from the set of contacts for display in the GUI.

19. The system of claim 15, further comprising instructions for performing the operation of:
displaying a user interface element on a contact in the GUI for indicating a number of unread communications from the contact.

20. The system of claim 15, further comprising instructions for performing the operation of:
receiving second user input associated with a thumbnail of a contact displayed in the GUI; and
responsive to the second user input, presenting a window for the contact having a timeline display, the timeline display including sections corresponding to days, the sections displaying a descriptor for each communication or media received from the contact.

21. The system of claim 20, further comprising instructions for performing the operation of:
receiving third user input selecting a type of communication to be displayed in the sections of the timeline display; and
displaying only communications of the communication type in the sections of the timeline display.

22. The system of claim 20, the instructions including instructions for performing the operation of:
receiving third user input selecting a network service or site; and
displaying options for interacting with the network service or site.

23. The system of claim 15, where media associated with the contact is displayed in at least one section of the timeline display.

24. The system of claim 23, where the media is received from a network service or site.

25. A system comprising:
one or more processors;
memory coupled to the one or more processors and configured to store instructions for causing the one or more processors to perform operations comprising:
generating a graphical user interface (GUI) for display on a device;
determining a set of contacts;
ranking the contacts according to a ranking system; and
displaying thumbnails representing the set of contacts in the GUI according to the ranking.

26. The system of claim 25, where determining a set of contacts includes collecting contacts from a virtual address book on the device.

27. The system of claim 25, where ranking the contacts according to a ranking system, comprises:
ranking a contact based on a previous interaction with the contact.

28. The system of claim 25, where ranking the contacts according to a ranking system, comprises:
ranking a contact based on an upcoming event associated with the contact.
